(19) United States
(12) Patent Application Publication
(10) Pub. No.: US 2008/0271636 A1
(43) Pub. Date: Nov. 6, 2008

(54) Composition for Dental Impression Treatment Material and Preparation Thereof

(76) Inventors: Jae-Won Kim, Daegu (KR); Seok-Jong Hong, Gyeongsangnam-do (KR); Suk-Young Kim, Gyeongsangbuk-do (KR)

Correspondence Address: OSTROLENK FABER GERB & SOFFEN, 1180 AVENUE OF THE AMERICAS, NEW YORK, NY, 100368403, US

(21) Appl. No.: 11/720,143

(22) PCT Filed: Nov. 28, 2005
(86) PCT No.: PCT/KR05/04015

§ 371 Date: May 2, 2008

(30) Foreign Application Priority Data
Nov. 29, 2004 (KR) 10-2004-0098616

(51) Int. Cl. C09K 3/00

(52) U.S. Cl. 106/35

(57) ABSTRACT

The present invention relates to a composition for dental impression treatment material and preparation thereof for the purpose of obtaining the superior impression in restoration treatment for dental prosthesis, and for the gingival retraction from the teeth, gingival oozing inhibition and stanching. The composition preferably comprises 67.70 to 71.85% by weight of kaolin clay, 16.05 to 20.00% by weight of distilled water, 10.83 to 11.50% by weight of aluminum chloride hexahydrate, 0.14 to 1.02% by weight of starch powder, 0.42 to 0.43% by weight of silicone oil, 0.03% by weight of coloring agent.

### TECHNICAL FIELD

The present invention relates to a composition for dental impression treatment material and preparation thereof for the purpose of obtaining the superior impression in restoration treatment for dental prosthesis, and for gingival retraction from the teeth, gingival oozing inhibition and stanching, more particularly to a composition comprising 67.70 to 71.85% by weight of kaolin clay, 16.05 to 20.00% by weight of distilled water, 10.83 to 11.50% by weight of aluminum chloride hexahydrate, 0.14 to 1.02% by weight of starch powder, 0.42 to 0.43% by weight of silicone oil, 0.03% by weight of coloring agent (pigment mixture of yellow color and blue color in the ratio of 4:1 by weight).

The composition according to the invention is prepared by adding organic and inorganic additives to refined distilled water, completely melting the additives, adding clay powder, and mixing until the mixture is in a very homogeneous condition. The composition of the invention exhibits superior effect on the gingival retraction, gingival oozing inhibition and stanching compared to the conventional dental impression treatment method using a cotton-based cord (also called as polymer cord or gingival cord). Also, the composition of the invention completely reduces the pain during treating patients, shortens the treatment time, and does not cause any gingival prognathism occurred as the fatal defect when using the gingival cord, therefore it may be usefully used as impression treatment material.

The present invention relates to a useful insertion material for sufficient opening of a gingival sulcus and for inhibiting gingival oozing and bleeding.

### BACKGROUND ART

The gingival sulcus (A of FIG. 1) located in between a tooth and gingiva is known as a virtual space necessary to be opened before the impression acquisition, and generates the efficacy in the treatment method such as acquiring the clean and dry condition on the lower part of gingiva, combining and closing of decayed teeth.

The currently known gingival sulcus opening technology is divided into two types that depend on gingival eviction or retraction. The gingival eviction is influenced by an electric bistoury or the interference of a diamond drill by a turbine of a rotary curet. In the event of using the electric bistoury, it makes gingival incision, and it heads from the peak of gingival scallop to the lower part of groove in the gingival sulcus. Although this method opens the gingival sulcus along with the appropriate stanching, it provokes the damage to the gingiva and pain in treatment for patients, and it generally required partial anesthesia and causes gingival degeneration.

In the event of using the diamond drill, the drill that moves inside the gingival sulcus in order to make a bevel within the maximum permitted treatment tears the gingival area. This method is used only for a few limited cases. And this method also has the shortcomings like the above-mentioned electric bistoury. In addition, it causes significant bleeding that requires the second stanching. The gingival retraction process is determined by inserting insertion materials inside the gingival sulcus.

For a recent method, the gingival cord is skillfully used with or without the addition of solution for improving the gingival retraction. The gingival cord is inserted along with a metal dual band device inside the gingival sulcus beyond the range of maximum permitted treatment of the teeth incision that depends on extreme method or several types. However, this method has many shortcomings in several aspects. Firstly, it is very difficult and weak to locate the gingival cord around the teeth area. This method causes pain during treatment and requires anesthesia around the treatment area. Moreover, when recovering the gingival cord for impression acquisition, frequent tissue damage such as bleeding and oozing occurs in adhesive epithelium part (B of FIG. 1).

Another gingival retraction method using insertion material is to use a ring inserted along with several liquid (hemostatic agent, anesthesia agent and others). This method also has the same shortcomings as mentioned in the gingival cord.

Third, one of the gingival retraction methods is to acquire the gingival retraction by occlusion pressure of upper jaw and lower jaw, that is to cover a cap made of sponge material inserted on the gingival sulcus along with several solution on the teeth. Although it is easy and fast, this method lacks the accuracy of treatment and sufficient gingival retraction effect by this method is uncertain. Therefore, this method is used only to securely stanch after the gingival eviction.

Finally, as one of several insertion materials for certain impression acquisition, a useful method of using a injection of liquid type that brings the hardening by the chemical reaction (before mixing of a hardening agent) or physical expansion (absorption of water) has been used now. However, a composition consisting of such a liquid type is very inappropriate for the purpose of gingival sulcus opening that requires high pressure. In addition, a material used for the purpose of hardening is impossible to control the gingival retraction. And, it takes a very long period of time for the treatment effect of the composition.

### DISCLOSURE OF INVENTION

### Technical Problem

It is an object of the present invention to solve many shortcomings of the conventional dental impression treatment material.

It is other object of the present invention to provide an innovative insertion material having the well-opened normal gingival retraction effect, oozing inhibiting and stanching effect by acquiring the gingival area without any damage to the tissues around the gingiva before treatment.

It is another object of the present invention to provide a composition for dental impression treatment material and preparation thereof, as an insertion material to obtain superior impression in the restoration treatment for the dental prosthesis, and to acquire the gingival opening, oozing inhibition and stanching effect before the treatment, which has the viscous property capable of sufficiently enduring against the pressure necessary to acquire the sufficient space between the teeth and gingiva without any damage to the tissue, anatomically structural deformation of the gingival area adjacent to the teeth and external injection.

### Technical Solution

To accomplish the objects, the present invention provides a composition for dental impression treatment material, comprising 60 to 80% by weight of clay, 10 to 30% by weight of distilled water, 5 to 15% by weight of hemostatic agent, 0.1 to 5% by weight of viscosity modifier, 0.01 to 1% by weight of coloring agent.

In the present invention, the clay is preferably kaolin clay.

In the present invention, the hemostatic agent is preferably aluminum chloride hexahydrate or iron (III) sulfate, more preferably aluminum chloride hexahydrate.

In the present invention, the viscosity modifier is selected from silicone oil, starch powder, polyvinyl ethylene glycol, stearic acid and sodium lauryl sulfate, preferably silicone oil and starch power.

In the present invention, the coloring agent is preferably pigment mixture of yellow color and blue color in the ratio of 4:1 by weight.

More preferably, the composition of the present invention comprises 67.70 to 71.85% by weight of kaolin clay, 16.05 to 20.00% by weight of distilled water, 10.83 to 11.50% by weight of aluminum chloride hexahydrate, 0.14 to 1.02% by weight of starch powder, 0.42 to 0.43% by weight of silicone oil, 0.03% by weight of pigment mixture of yellow color and blue color in the ratio of 4:1 by weight.

Also, the present invention provides a process for preparing a composition for dental impression treatment material, comprising the steps of: adding hemostatic agent to distilled water and melting the hemostatic agent by using an ultrasonic generator; adding coloring agent to the melted solution and dispersing the melted solution by using the ultrasonic generator; gradually adding clay to the dispersed solution to make homogeneous mixture; and adding viscosity modifier to the mixture to make paste form.

More preferably, the process comprises the steps of: adding 10.83 to 11.50% by weight of aluminum chloride hexahydrate to 16.05 to 20.00% by weight of distilled water and melting the aluminum chloride hexahydrate by using the ultrasonic generator; adding 0.03% by weight of pigment mixture of yellow color and blue color in the ratio of 4:1 by weight to the melted solution and dispersing the melted solution by using the ultrasonic generator; adding 0.42 to 0.43% by weight of silicone oil to the dispersed solution; gradually adding 67.70 to 71.85% by weight of kaolin clay to the dispersed solution to make homogeneous mixture; and adding 0.14 to 1.02% by weight of starch powder to the mixture to make paste form.

### BRIEF DESCRIPTION OF DRAWINGS

The above and other objects, features and other advantages of the present invention will be more clearly understood from the following detailed description taken in conjunction with the accompanying drawings, in which:

FIG. 1 is a cross-sectional view of oral cavity in which the dental impression treatment material of the invention is used.

FIG. 2 shows a preparation procedure of the composition of the invention.

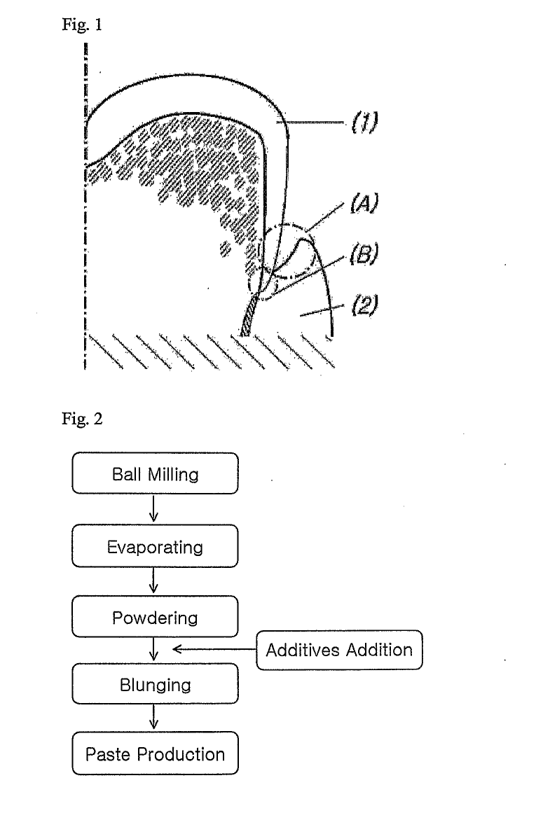

In FIG. 1, numeral 1 indicates enamel, 2 gingiva, A gingival sulcus, B epithelium adhesive part, respectively.

### BEST MODE

As shown in FIG. 2, the process for preparing the composition of the present invention comprises ball milling of kaolin clay, evaporating, powdering, additives addition, blunging and paste production.

The kaolin clay is used as powder form pulverized by the ball milling. The ball milling is the process for finely wet-pulverizing the lump powder strongly or weakly lumped between the powder particles in early stage and for allowing the homogeneity in particle size of the kaolin clay powder having the average particle size of less than 20 μm used as starting material,

First, a 1,000 cc polyurethane pot for ball milling is prepared and alumina balls are filled in the pot until they reach to the nearly half of the pot and then 120 to 150 g of the kaolin clay powder is added and then approximately 800 cc of alcohol is poured. After closing a lid of the pot so that the contents in the pot are not leaked out, the pot is placed on a pot table for rotary ball milling and then the contents are milled at the rotation speed of approximately 150 rpm for 1 to 3 hours and consequently the slurry is prepared. Then the slurry is put into a metal vessel and the vessel is placed in the temperature controlled (approximately 80° C. of alcohol volatile point) dryer for 12 to 24 hours and consequently the well-dried powder is obtained by the evaporation.

In order to prepare the composition of the invention, the powder and each additive are added to a kneader with a twin-screw mixer and then blunged until the homogenous paste is obtained. First, adding 10.83 to 11.50% by weight of aluminum chloride hexahydrate is added to 16.05 to 20.00% by weight of distilled water and melted by using an ultrasonic generator. Then, 0.03% by weight of coloring agent is added to the melted solution and dispersed by using the ultrasonic generator. The coloring agent is preferably pigment mixture of yellow color and blue color in the ratio of 4:1 by weight. Then, to allow the compression capability, 0.42 to 0.43% by weight of silicone oil as one of the viscosity modifiers is added to the dispersed solution and then stirred by using polyethylene rod. Then, the resultant solution is poured to the entrance of the kneader and 67.70 to 71.85% by weight of kaolin clay is gradually added to the solution and then kneaded for about 5 minutes until the homogeneous mixing is attained. Finally, 0.14 to 1.02% by weight of starch powder is added to the mixture and consequently the paste is prepared.

In case that the amount of the aluminum chloride hexahydrate exceeds 11.50% by weight, the human body may be exposed to damages by the oxidation and corrosion by the aluminum chloride, and in case of less than 10.83% by weight, the hemostatic effect may be lowered. In case that the amount of the silicone oil exceeds 0.43% by weight, the hydrophobic property is declined to reduce the hydrophilic property with the gingiva, and in case of less than 0.42% by weight, the viscosity gets lowered. In case that the amount of the kaolin clay exceeds 71.85% by weight, the paste production is impossible, and in case of less than 67.70% by weight, the viscosity gets lowered. In case that the amount of the starch powder exceeds 1.02% by weight, the viscosity gets so higher that the gellation is not occurred, and in case of less than 0.14% by weight, it does not take a role of bonding agent. The amount of the distilled water has to be adjusted in accordance with the above ratio.

The present invention will now be described in more detail with reference to the following examples. However, these examples are given for the purpose of illustration and are not to be construed as limiting the scope of the invention.

### EXAMPLE 1

11.5% by weight of aluminum chloride hexahydrate was added to 16.05% by weight of distilled water and melted by using the ultrasonic generator. Then, 0.03% by weight of coloring agent (pigment mixture of yellow color and blue color in the ratio of 4:1 by weight) was added to the melted solution and dispersed by using the ultrasonic generator. Then, to allow the compression capability, 0.43% by weight of silicone oil as the viscosity modifier was added to the dispersed solution and then stirred. Then, the resultant solution was poured to the kneader and 71.85% by weight of kaolin clay (less than 20 μm) was gradually added to the solution and then the homogeneous mixture is prepared by kneading. Finally, 0.14% by weight of starch powder was added to the mixture and consequently the dental impression treatment material in the form of the paste is prepared.

### EXAMPLE 2

11.26% by weight of aluminum chloride hexahydrate was added to 17.8% by weight of distilled water and melted by using the ultrasonic generator. Then, 0.03% by weight of coloring agent (pigment mixture of yellow color and blue color in the ratio of 4:1 by weight) was added to the melted solution and dispersed by using the ultrasonic generator. Then, to allow the compression capability, 0.42% by weight of silicone oil as the viscosity modifier was added to the dispersed solution and then stirred. Then, the resultant solution was poured to the kneader and 70.35% by weight of kaolin clay (less than 20 μm) was gradually added to the solution and then the homogeneous mixture is prepared by kneading. Finally, 0.14% by weight of starch powder was added to the mixture and consequently the dental impression treatment material in the form of the paste is prepared.

### EXAMPLE 3

10.83% by weight of aluminum chloride hexahydrate was added to 20% by weight of distilled water and melted by using the ultrasonic generator. Then, 0.03% by weight of coloring agent (pigment mixture of yellow color and blue color in the ratio of 4:1 by weight) was added to the melted solution and dispersed by using the ultrasonic generator. Then, to allow the compression capability, 0.42% by weight of silicone oil as the viscosity modifier was added to the dispersed solution and then stirred. Then, the resultant solution was poured to the kneader and 67.7% by weight of kaolin clay (less than 20 μm) was gradually added to the solution and then the homogeneous mixture is prepared by kneading. Finally, 1.02% by weight of starch powder was added to the mixture and consequently the dental impression treatment material in the form of the paste is prepared.

The product of the invention is put into a small capsule after the paste production is completed and the paste is extruded by using a compression gun. In the invention, the extrusion of the paste means that the paste in stationary condition is deformed to make a shear flow as the water forwardly flows in parallel to a surface. This is referred as a shear deformation. In order to make the shear deformation of the paste, a force as the paste is deformed is required when the paste is sprayed by the compression gun. This force may be same as a shear stress (a force against the deformation). Namely, if the shear stress is small, less force is necessary in using the compression gun, thereby providing the convenience in the treatment. In case that the viscosity is very high, so much force is required to deform the paste and also shear stress is greatly increased as the force.

However, in case of some materials, the shear stress gets smaller as it is deformed even though the viscosity is high. Such a viscosity behavior is referred to the pseudoplastic behavior. In case of material having the same purpose as the present invention, preferably it has to exhibit the pseudoplastic behavior. In addition, there are dilatant behavior in which the shear stress is increased as the deformation is increased, and Newtonian behavior in which the shear stress is increased in proportion to the deformation.

Therefore, in case of the conventional dental impression treatment material product, the viscosity decreases as the shear rate increases at room temperature, and the dental impression treatment material product of the present invention shows the same behavior like the conventional product. When the same shear stress is applied, the initial viscosity of the conventional product is almost 2.5 times higher than that of the product of the present invention. Thus, when using the same compression gun, in case of the product of the invention, the force required when compressing is 2.5 times less than that of the conventional product. In the event of the final viscosity, the product of the invention has lower viscosity than the conventional product.

The paste viscosity of the composition of the invention is larger than that of the conventional product, the paste of the invention is easily inserted between teeth and gingiva, and the density of the material enables the perfectly controlled opening of the gingival sulcus. The paste viscosity of the invention shows the plastic viscosity when measured at 25° C. The paste of the invention is comprised of kaolin clay having the particle size preferably less than 5 μm and water, and also coloring agent, hemostatic agent, viscosity modifier and sterilizing agent.

The use of the material according to the invention evades the several shortcomings of the conventional insertion materials as mentioned above and provides the sophistication to enable the improved gingival retraction. The efficacy of the invention is to substantially inhibit the bleeding and oozing, and to enable the completely painless treatment. Since the pressure acting on the gingival tissue from the composition of the invention only depends on the viscosity property of the inserted paste, there is no damage to the gingival tissue and the gingival retraction may be easily acquired.

The present invention is comprised of the insertion material having the viscous property capable of sufficiently enduring against the pressure necessary to acquire the sufficient space between the teeth and gingiva without any damage to the tissue and anatomically structural deformation of the gingival area adjacent to the teeth. The paste of the invention has the vital adaptability and is able to pass the small cannular diameter (for example 0.5 to 1.2 mm) for the insertion.

According to the sequence for preparing the composition of the invention, the material that specifically comprises the kaolin clay may be used and the viscosity may be easily controlled along with the water as solvent. In addition, several additional additives such as coloring agent, hemostatic agent and sterilizing agent can be used. The viscosity modifier added to the paste of the invention may be one or more selected from the group consisting of silicone oil, starch powder, polyvinyl ethylene glycol, stearic acid, sodium lauryl sulfate and others. The coloring agent added to the paste of the invention may be one or more of zinc oxide and other pigments. The hemostatic agent added to the paste of the invention may be aluminum chloride hexahydrate or iron (iii) sulfate.

The insertion material prepared according to the invention may be inserted into the inside of the gingival sulcus through the cannula that has the diameter of 0.5 to 1.2 mm and is bent with 35 degree. The depth of gingival sulcus, the thickness and tonicity of the gingival area may be easily changed depending on the surrounding part of the teeth. Therefore, it is recommended to confirm the status of the gingival retraction each time in consideration of the above point.

The use of the product having the viscosity property according to the invention enables to obtain the broad and normal gingival retraction in the entire surrounding area around the teeth. In addition, such a product inside the gingival sulcus has the advantage capable of using with leaning against the teeth and there is no need to apply the pressure on the gingival tissue with the cannula. Only the viscosity of the product itself influences the pressure applied on the gingival tissue. According to the invention, before the impression acquisition, the inserted material may be easily removed by using the washing gun with the air and water without the assistance of any device and it dose not causes any damage to the gingival tissue.

The insertion material according the invention may be used even after the gingival eviction process by the rotating curet or electric bistoury to ensure the maintenance of the opened gingival sulcus and the stanching, and provides the improved gingival retraction in the gingival treatment. The dental impression treatment material of the invention may easily reach the maximum permitted treatment range and it induces the gingival retraction without any damage to the gingival tissue, and it enables the easy and fast treatment and painless treatment.

### INDUSTRIAL APPLICABILITY

The present invention provides a composition for dental impression treatment material and preparation thereof for the purpose of obtaining the superior impression in restoration treatment for dental prosthesis, and for the gingival retraction and gingival oozing inhibition and stanching.

The composition according to the invention exhibits superior effect on the gingival retraction, gingival oozing inhibition and stanching compared to the conventional dental impression treatment method using the gingival cord. Also, the composition of the invention completely inhibits the pain during treating patients and it shortens the treatment time, particularly it does not cause any gingival prognathism occurred as the fatal defect when using the gingival cord, therefore it may be usefully used as impression treatment material and it is very useful in the medical industry.

1. A composition for dental impression treatment material, comprising 60 to 80% by weight of clay, 10 to 30% by weight of distilled water, 5 to 15% by weight of hemostatic agent, 0.1 to 5% by weight of viscosity modifier, 0.01 to 1% by weight of coloring agent.

2. The composition of claim 1, wherein the clay is kaolin clay.

3. The composition of claim 1, wherein the hemostatic agent is aluminum chloride hexahydrate or iron (III) sulfate.

4. The composition of claim 1, wherein the viscosity modifier is selected from silicone oil, starch powder, polyvinyl ethylene glycol, stearic acid and sodium lauryl sulfate.

5. The composition of claim 1, wherein the coloring agent is pigment mixture of yellow color and blue color in the ratio of 4:1 by weight.

6. The composition of claim 1, comprising 67.70 to 71.85% by weight of kaolin clay, 16.05 to 20.00% by weight of distilled water, 10.83 to 11.50% by weight of aluminum chloride hexahydrate, 0.14 to 1.02% by weight of starch powder, 0.42 to 0.43% by weight of silicone oil, 0.03% by weight of pigment mixture of yellow color and blue color in the ratio of 4:1 by weight.

7. A process for preparing a composition for dental impression treatment material, comprising the steps of:
adding hemostatic agent to distilled water and melting the hemostatic agent by using an ultrasonic generator;
adding coloring agent to the melted solution and dispersing the melted solution by using the ultrasonic generator;
gradually adding clay to the dispersed solution to make homogeneous mixture; and
adding viscosity modifier to the mixture to make paste form.

8. The process of claim 7, comprising the steps of:
adding 10.83 to 11.50% by weight of aluminum chloride hexahydrate to 16.05 to 20.00% by weight of distilled water and melting the aluminum chloride hexahydrate by using the ultrasonic generator;
adding 0.03% by weight of pigment mixture of yellow color and blue color in the ratio of 4:1 by weight to the melted solution and dispersing the melted solution by using the ultrasonic generator;
adding 0.42 to 0.43% by weight of silicone oil to the dispersed solution;
gradually adding 67.70 to 71.85% by weight of kaolin clay to the dispersed solution to make homogeneous mixture; and
adding 0.14 to 1.02% by weight of starch powder to the mixture to make paste form.
